(19) United States
(12) Patent Application Publication
(10) Pub. No.: US 2018/0095275 A1
(43) Pub. Date: Apr. 5, 2018

(54) IMAGE-CAPTURING DEVICE, MULTI-LENS CAMERA, AND METHOD FOR MANUFACTURING IMAGE-CAPTURING DEVICE

(71) Applicant: NIKON CORPORATION, Tokyo (JP)

(72) Inventor: Masao NAKAJIMA, Kawasaki-shi (JP)

(73) Assignee: NIKON CORPORATION, Tokyo (JP)

(21) Appl. No.: 15/562,687

(22) PCT Filed: Mar. 29, 2016
(86) PCT No.: PCT/JP2016/060138

§ 371 Date: Sep. 28, 2017

(30) Foreign Application Priority Data
Mar. 30, 2015 (JP) 2015-068875

(51) Int. Cl. G02B 27/00; G02B 27/64; H04N 5/225; H04N 5/232; G02B 7/08

(52) U.S. Cl. CPC G02B 27/0075; G02B 27/646; G02B 7/08; H04N 5/23264; H04N 5/2254

(57) ABSTRACT

An image-capturing device includes: a micro-lens array in which a plurality of micro-lenses are arranged in a two dimensional configuration; an image sensor that comprises a plurality of pixel groups each comprising a plurality of pixels, and that receives light with each of the pixel groups that has passed through a respective micro-lens of the micro-lens array; and a drive unit that changes a positional relationship of the image sensor and the micro-lens array to prevent blurring of an image captured by the pixel groups.

### TECHNICAL FIELD

The present invention relates to an image-capturing device, to a multi-lens camera, and to a method for manufacturing an image-capturing device.

### BACKGROUND ART

In a camera that employs light field photography technology (a multi-lens camera), a technique is known of shifting the entire micro-lens array in a direction in which the micro-lenses are aligned (i.e. in a direction orthogonal to the optical axis) (refer to PTL1).

### CITATION LIST

### Patent Literature

PTL1: Japanese Laid-Open Patent Publication No. 2012-60460.

### SUMMARY OF INVENTION

### Technical Problem

This conventional technology performs image capture while simulating that the array pitch of the micro-lenses is shortened, but is not capable of suppressing influence due to shaking during photography.

### Solution to Technical Problem

An image-capturing device according to a first aspect of the present invention comprises: a micro-lens array in which a plurality of micro-lenses are arranged in a two dimensional configuration; an image sensor that comprises a plurality of pixel groups each comprising a plurality of pixels, and that receives light with each of the pixel groups that has passed through a respective micro-lens of the micro-lens array; and a drive unit that changes a positional relationship of the image sensor and the micro-lens array to prevent blurring of an image captured by the pixel groups.

According to a second aspect of the present invention, in the image-capturing device according to the first aspect, it is preferable that the drive unit changes the positional relationship of the image sensor and the micro-lens array based on a signal that indicates shaking of the image-capturing device.

According to a third aspect of the present invention, in the image-capturing device according to the first or second aspect, it is preferable that the drive unit is provided upon at least one of a portion of the micro-lens array facing toward the image sensor and a side portion of the micro-lens array, and changes a position of the micro-lens array with respect to the image sensor.

According to a fourth aspect of the present invention, in the image-capturing device according to the third aspect, it is preferable that the drive unit is provided at four corners of the micro-lens array, upon the portion of the micro-lens array facing toward the image sensor or the side portion of the micro-lens array.

According to a fifth aspect of the present invention, in the image-capturing device according to the third aspect, it is preferable that the drive unit is provided at four sides of the micro-lens array, upon the portion of the micro-lens array facing toward the image sensor or the side portion of the micro-lens array.

According to a sixth aspect of the present invention, in the image-capturing device according to any one of the first through fifth aspects, it is preferable that the drive unit at least shifts the micro-lens array by translation along directions of two axes that intersect on the two dimensional configuration in which the plurality of micro-lenses are arranged, and rotationally around an axis that is orthogonal to the two axes.

According to a seventh aspect of the present invention, in the image-capturing device according to any one of the first through sixth aspects, it is preferable that the drive unit includes a piezoelectric element.

According to an eighth aspect of the present invention, in the image-capturing device according to the seventh aspect, it is preferable that the piezoelectric element has a displacement amplification function.

According to a ninth aspect of the present invention, in the image-capturing device according to any one of the first through eighth aspects, it is preferable to further comprise partition walls that are provided between the micro-lens array and the image sensor, and that allow light that has passed through a single micro-lens to be received by a corresponding pixel group of the pixel groups, while hindering light that has passed through others of the micro-lenses from falling upon the corresponding pixel group.

According to a tenth aspect of the present invention, in the image-capturing device according to the ninth aspect, it is preferable that at least, either portions of the partition walls that face toward the micro-lens array are connected to the micro-lens array, or portions of the partition walls that face toward the image sensor are connected to the imaging sensor.

According to an 11th aspect of the present invention, in the image-capturing device according to the ninth aspect, it is preferable that the partition walls are disposed so that either the partition walls and the micro-lens array, or the partition walls and the image sensor, are separated from one another.

According to a 12th aspect, in the image-capturing device according to the ninth aspect, it is preferable that portions of the partition walls that face toward the micro-lens array are connected to the micro-lens array, and portions of the partition walls that face toward the image sensor are connected to the image sensor.

According to a 13th aspect of the present invention, in the image-capturing device according to the 12th aspect, it is preferable that at least portions of the partition walls are formed as elastic members.

According to a 14th aspect of the present invention, in the image-capturing device according to any one of the first through 13th aspects, it is preferable to further comprise an information generation unit that generates information specifying limitation on signals from the pixel groups upon the positional relationship between the image sensor and the micro-lens array being changed.

According to a 15th aspect of the present invention, in the image-capturing device according to the 14th aspect, it is preferable that upon performing by the image sensor photoelectric conversion in a state in which the positional relationship between the image sensor and the micro-lens array has changed, the information generation unit generates appended information specifying that a number of signals used for signal processing is limited.

According to a 16th aspect of the present invention, in the image-capturing device according to the 15th aspect, it is preferable that the information generation unit generates appended information specifying that the number of the signals is limited by eliminating a signal from a pixel at an edge portion of a pixel group that receives light that has passed through a single micro-lens.

A multi-lens camera according to a 17th aspect of the present invention comprises an image-capturing device according to any one of the first through 16th aspects.

A method for manufacturing an image-capturing device according to an 18th aspect of the present invention, comprises: preparing a micro-lens array in which a plurality of micro-lenses are arranged in a two dimensional configuration; preparing an image sensor that comprises a plurality of pixel groups each comprising a plurality of pixels, and that receives light with each of the pixel groups that has passed through a respective micro-lens of the micro-lens array; preparing a drive unit that changes a positional relationship of the image sensor and the micro-lens array to prevent blurring of an image captured by the pixel groups; and assembling together the micro-lens array, the image sensor, and the drive unit.

An image-capturing device according to a 19th aspect of the present invention comprises: a micro-lens array in which a plurality of micro-lenses are arranged in a two dimensional configuration; an image sensor that comprises a plurality of pixel groups each comprising a plurality of pixels, and that receives light with each of the pixel groups that has passed through a respective micro-lens of the micro-lens array; and partition walls that are provided between the micro-lens array and the image sensor, and that allow light that has passed through a single micro-lens to be received by a corresponding pixel group of the pixel groups, while hindering light that has passed through others of the micro-lenses from falling upon the corresponding pixel group; wherein the partition walls are arranged so as, even if the positional relationship between the image sensor and the micro-lens array changes, to allow light that has passed through the single micro-lens to be received by the corresponding pixel group, while hindering light that has passed through others of the micro-lenses from falling upon the corresponding pixel group.

An image-capturing device according to a 20th aspect of the present invention comprises: a micro-lens array in which a plurality of micro-lenses are arranged in a two dimensional configuration; an image sensor that comprises a plurality of pixel groups each comprising a plurality of pixels, and that receives light with each of the pixel groups that has passed through a respective micro-lens of the micro-lens array; partition walls that are provided between the micro-lens array and the image sensor, and that allow light that has passed through a single micro-lens to be received by a corresponding pixel group of the pixel groups, while hindering light that has passed through others of the micro-lenses from falling upon the corresponding pixel group; and an information generation unit that generates information specifying limitation on signals from the pixel groups upon a positional relationship between the image sensor and the micro-lens array being changed.

### BRIEF DESCRIPTION OF DRAWINGS

FIG. 1 is a figure for explanation of the structure of principal portions of a light field camera;

FIG. 2 is a figure for explanation of a micro-lens array and piezo elements of FIG. 1;

FIG. 3 is an enlarged view of one of the piezo elements;

FIG. 4 is an enlarged view of portions of the micro-lens array and of an image sensor;

FIG. 5 is a figure for explanation of an example in which the micro-lens array of FIG. 4 is shifted by translation;

FIG. 6 is a flow chart for explanation of processing performed during VR operation by a control unit;

FIG. 7 is a figure schematically showing the optical system of the light field camera;

FIG. 8 is a figure showing an example of the image sensor as seen from an image capturing lens;

FIG. 9 is another figure showing an example of the image sensor as seen from the image capturing lens;

FIGS. 10(a) through 10(c) are figures for explanation of a procedure for assembling an image-capturing unit of an LF camera;

FIGS. 11(a) and 11(b) are figures for explanation of variant embodiments related to partition walls;

FIGS. 12(a) through 12(c) are figures for explanation of variant embodiments related to the positions of the piezo elements;

FIG. 13 is a figure showing the external appearance of a thin type light field camera;

FIG. 14 is a sectional view of an image-capturing unit of the light field camera of FIG. 13;

FIGS. 15(a) through 15(c) are figures for explanation of light incident upon pixel groups PXs during VR operation;

FIGS. 16(a) through 16(c) are further figures for explanation of light incident upon pixel groups PXs during VR operation; and

FIGS. 17(a) through 17(c) are yet further figures for explanation of light incident upon pixel groups PXs during VR operation.

### DESCRIPTION OF EMBODIMENTS

### Summary of Light Field Camera

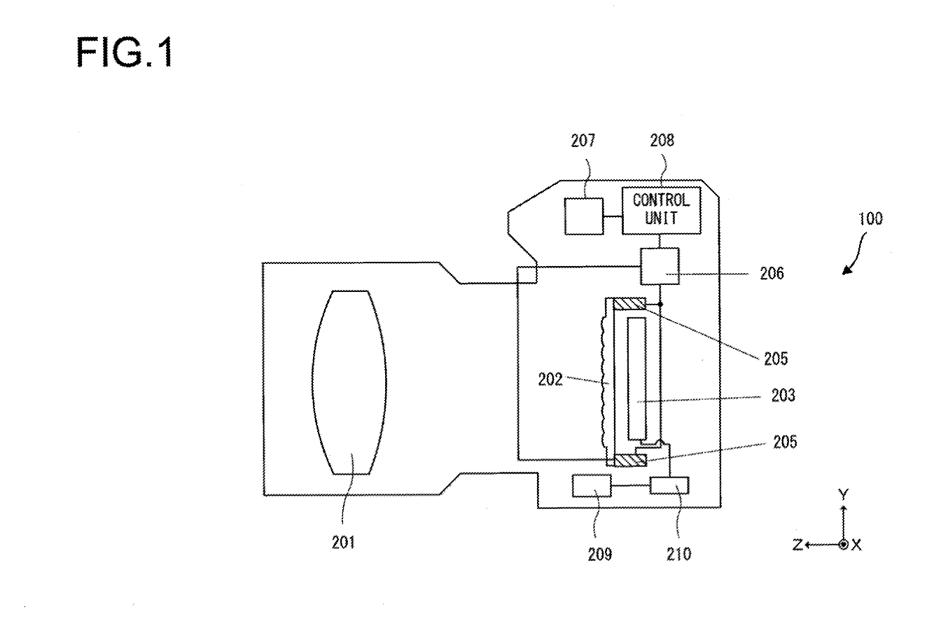

FIG. 1 is a figure for explanation of the structure of principal portions of a light field camera 100 (hereinafter termed an LF camera) according to an embodiment of the present invention. Generally, such an LF camera 100 captures a plurality of images whose points of view are different. In FIG. 1, an image capturing lens 201 projects light from a photographic subject upon a micro-lens array 202. The image capturing lens 201 is built to be interchangeable, and is used by being mounted on the body of the LF camera 100. Light from the photographic subject that is incident upon the micro-lens array 202 passes through the micro-lens array 202, and is photoelectrically converted by an image sensor 203.

It should be understood that it would also be acceptable for the image capturing lens to be built integrally with the body of the LF camera 100.

The pixel signals after photoelectric conversion are read out from the image sensor 203 and sent to an image processing unit 210. The image processing unit 210 performs predetermined image processing upon the pixel signals. And, after the image processing, the image data is recorded upon a recording medium 209 such as a memory card or the like.

It should be understood that it would also be acceptable to arrange for the pixel signals read out from the image sensor 203 to be recorded upon the recording medium 209 without having being subjected to any image processing.

The LF camera 100 of this embodiment is endowed with a VR (Vibration Reduction) function that suppresses influence of shaking (so called “camera-shaking”) generated when image capture is performed while the camera is being held by hand. It should be understood that this VR function is not limited to reduce the influence of rocking or vibration generated when photography is being performed while holding the camera by hand; for example, it could also be applied to suppression of the influence of rocking or vibration when the LF camera is fixed to some article of attire (for example, a helmet or the like) (such as for example, shaking during photography when the LF camera is being used as a so-called action camera).

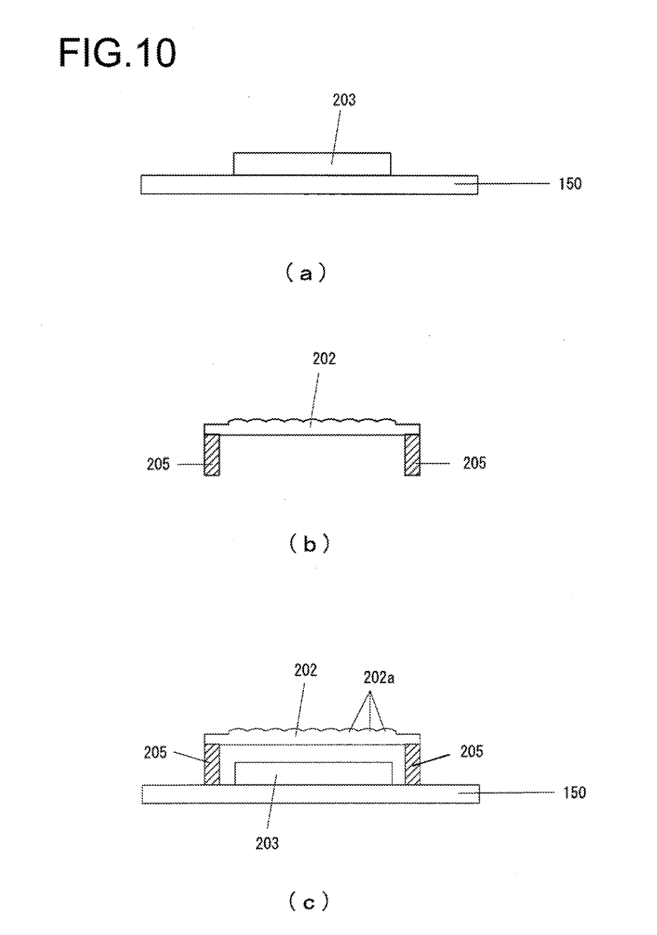

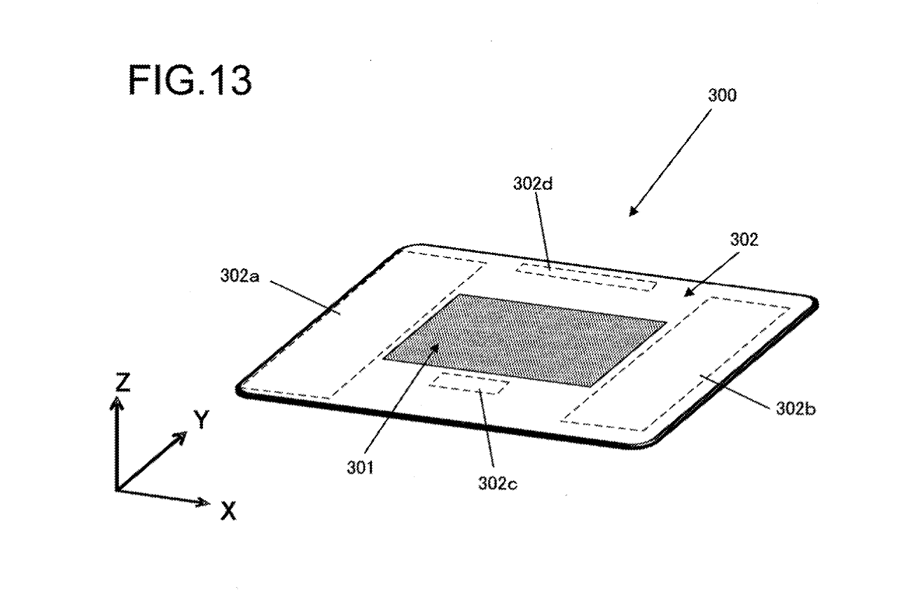

It should be understood that it is not only possible for the image-capturing unit shown in FIG. 10 to be applied to the LF camera 100; as will be described hereinafter, it could also be applied to a thin type LF camera 300 (refer to FIG. 13). Due to its thinness, such a thin type LF camera 300 can be installed in locations of various types (places for installation). The VR function described above suppresses the influence of camera shaking engendered by vibration of the place for installation in which the thin type LF camera 300 is installed. The details of this VR operation will be described hereinafter. Metadata, for example, specifying that VR operation was being performed may be appended to image data captured during VR operation. Moreover, in addition to such information specifying that VR operation was being performed, it may also be arranged for the metadata to include information of the acceleration at which the LF camera 100 was shifted.

The micro-lens array 202 is built as an array in which minute lenses (micro-lenses 202a that will be described hereinafter) are arranged two-dimensionally in a lattice configuration or in a honeycomb configuration, and is provided upon the image capturing surface side of the image sensor 203 (i.e. on its side that faces toward the image capturing lens 201).

The micro-lens array 202 is supported by piezo elements 205, which are examples of one type of piezoelectric element. One end of each of the piezo elements 205 is fixed to the micro-lens array 202, while its other end is fixed to a base portion 150 (refer to FIG. 10) upon which the image sensor 203 is mounted. Due to this, it is possible to change the relative positional relationship between the micro-lens array 202 and the image sensor 203 by driving the piezo elements 205. It should be understood that, instead of piezo elements, it would also be possible to employ voice coil motors or ultrasonic motors or the like as actuators.

In this embodiment, the VR operation described above is performed by controlling the positional relationship between the micro-lens array 202 and the image sensor 203. While, in this embodiment, an example is employed and explained in which the micro-lens array 202 is driven by the piezo elements 205, it would also be possible to provide a structure in which the image sensor 203 is driven by the piezo elements 205.

A shaking detection unit 207 comprises acceleration sensors and angular velocity sensors. For example, as shaking of the LF camera 100, the shaking detection unit 207 may detect movements by translation along the directions of each of an X axis, a Y axis, and a Z axis, and also may detect rotations around those axes.

With the coordinate axes shown in FIG. 1, light from the photographic subject proceeds in the −Z axis direction. Moreover, in FIG. 1, the direction upwards and orthogonal to the Z axis is taken as being the +Y axis direction, and the direction orthogonal to the drawing paper and orthogonal to the Z axis and to the Y axis is taken as being the +X axis direction. In some of the following figures, the orientation in each figure is given by taking the coordinate axes shown in FIG. 1 as reference.

A control unit 208 controls the image capturing operation of the LF camera 100. Moreover, the control unit 208 performs VR calculation on the basis of the detection signal from the shaking detection unit 207. The shaking detection unit 207 includes acceleration sensors, and the detection signal from the shaking detection unit 207 includes acceleration information corresponding to the movement of the LF camera 100. The VR calculation has the objective of calculating the drive direction and the drive amount for the micro-lens array 202 that are required for suppressing shaking of the image on the image sensor 203. This VR calculation is the same as, for example, the calculation in per se known VR operation for driving an image capturing lens, or the calculation in per se known VR operation for driving an image sensor. For this reason, detailed explanation of the VR calculation is omitted.

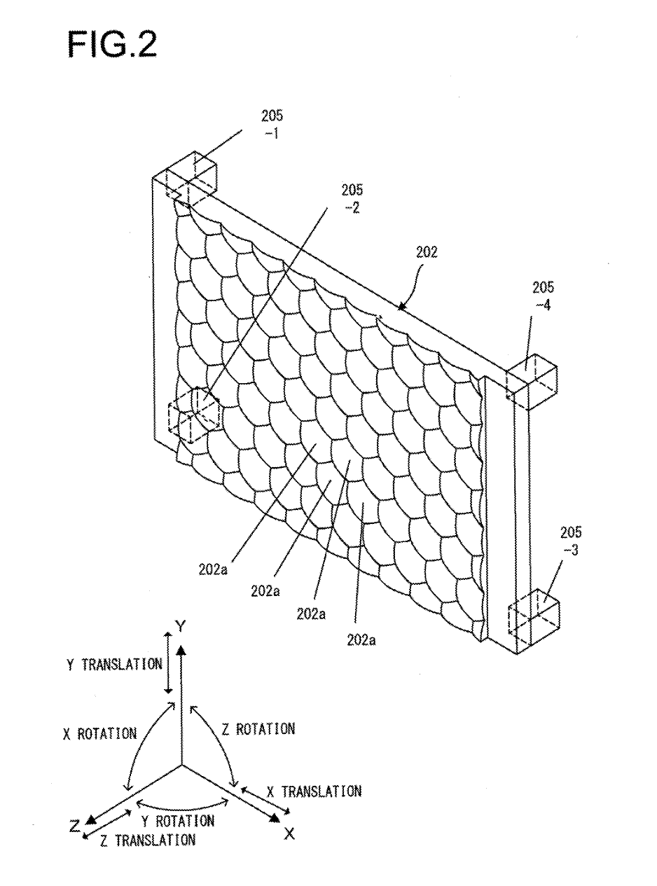

A piezo element drive circuit 206 drives the piezo elements 205 according to drive direction commands and drive amount commands from the control unit 208. FIG. 2 is a figure for explanation of the micro-lens array 202 and the piezo elements 205 of FIG. 1. In the FIG. 2 example, the plurality of micro-lenses 202a are arranged in a honeycomb configuration. The piezo elements 205 consist of four piezo elements 205-1 through 205-4. Each of the piezo elements 205-1 through 205-4 is fixed upon the surface of the rear side of the micro-lens array 202 (i.e. on its side facing toward the image sensor 203), respectively at the four corners of the micro-lens array 202.

### Piezo Elements

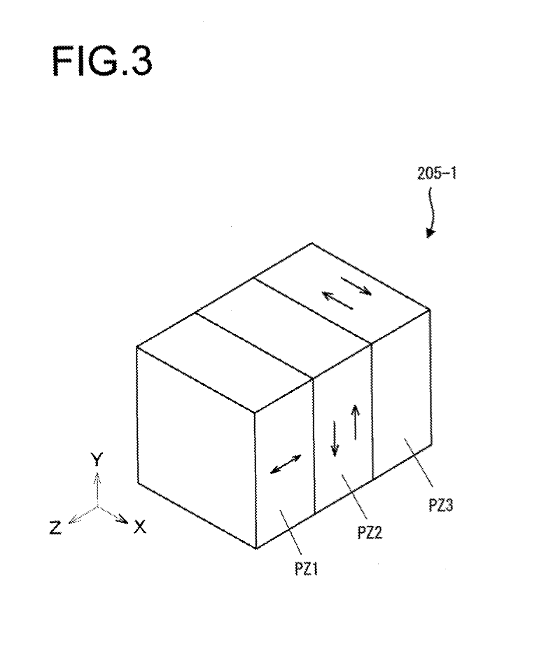

FIG. 3 is an enlarged view of the piezo element 205-1. Each of the other piezo elements 205-2 through 205-4 has a structure similar to that of this piezo element 205-1. In FIG. 3, the piezo element 205-1 is built by laminating together three piezo elements whose displacement directions are each different. In other words, the piezo element PZ1 is a piezo element of thickness expansion type that provides displacement in the Z axis direction. The piezo element PZ2 is a piezo element of thickness shear type that provides displacement in the Y axis direction. And the piezo element PZ3 is a piezo element of thickness shear type that provides displacement in the X axis direction. It should be understood that while the piezo element PZ2 and the piezo element PZ3 are arranged to provide displacement in the Y axis direction and in the X axis direction as shown in FIG. 3, it would also be acceptable to be arranged to provide displacement in the directions of any two axes in the X-Y plane that intersect one another.

Furthermore, the order in which the three piezo elements PZ1 through PZ3 are stacked together need not be as shown in FIG. 3; it would be acceptable for the order to be changed. Yet further, it would also be acceptable for the order in which the three piezo elements PZ1 through PZ3 are stacked together to be different for the various piezo elements 205-1 through 205-4. Even further, it would also be acceptable to provide each of the piezo elements with an amplification mechanism not shown in the figures. Such an amplification mechanism may be any of a hinge type, an elliptical shell type, a honeycomb link type, or the like. In addition it would also be acceptable, for example, to omit the piezo element PZ1 that provides translational movement in the Z axis direction. In this case, it would not be possible to provide rotational movement around the X axis, rotational movement around the Y axis, and translational movement in the Z axis direction, but it would be possible to reduce the dimension of the image-capturing unit in the Z axis direction in FIG. 1, i.e. to reduce its thickness.

Returning to FIG. 2, if each of the four piezo elements 205-1 through 205-4 provides displacement in the same direction (i.e. in the X axis direction, in the Y axis direction, or in the Z axis direction), then the micro-lens array 202 can be shifted by translation in the direction of each of the axes with respect to the image sensor 203.

Furthermore if, among the four piezo elements 205-1 through 205-4, the displacement provided in the Z axis direction is opposite between the piezo elements 205-1 and 205-4 that are positioned on the upper side in FIG. 2 and the piezo elements 205-2 and 205-3 that are positioned on the lower side in FIG. 2, then the micro-lens array 202 can be rotated around the X axis with respect to the image sensor 203.

Moreover if, among the four piezo elements 205-1 through 205-4, the displacement provided in the Z axis direction is opposite between the piezo elements 205-3 and 205-4 that are positioned on the right side in FIG. 2 and the piezo elements 205-1 and 205-2 that are positioned on the left side in FIG. 2, then the micro-lens array 202 can be rotated around the Y axis with respect to the image sensor 203.

Even further, if the piezo element 205-1 provides displacement in the +Y axis direction, the piezo element 205-4 provides displacement in the +X axis direction, the piezo element 205-3 provides displacement in the −Y axis direction, and the piezo element 205-2 provides displacement in the −X axis direction, then the micro lens array 202 can be rotated in the clockwise direction around the Z axis with respect to the image sensor 203.

Yet further, if the direction of displacement provided by each of the piezo elements 205-1 through 205-4 is opposite to that described above, then the micro lens array 202 can be rotated in the anticlockwise direction around the Z axis with respect to the image sensor 203.

### Relative Positional Relationship of Micro-Lens Array and Image Sensor

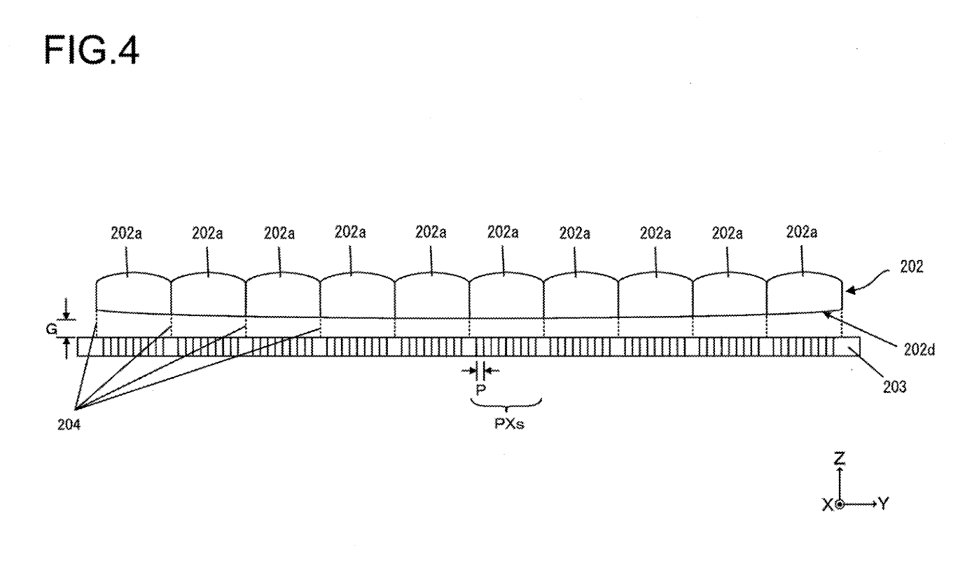

FIG. 4 is an enlarged view of portions of the micro-lens array 202 and of the image sensor 203 of FIG. 1. The reference symbol G in the figure indicates the gap between the micro-lens array 202 and the image sensor 203. The image sensor 203 comprises a plurality of pixels that are arranged two dimensionally, and detects the intensity of light at each pixel. The reference symbol P in the figure indicates the pixel pitch. A pixel group PXs including a plurality of pixels is allocated to each of the micro-lenses 202a. Each of the pixels in this pixel group PXs is arranged at a predetermined position with respect to the micro-lens 202a. Due to this, light that has passed through each of the micro-lenses 202a is divided into a plurality of rays of light by the respective pixel group PXs that is arranged behind that micro-lens 202a.

In FIG. 4, a surface 202d of the micro-lens array 202 on its side toward the image sensor 203 is curved with respect to the X-Y plane. The reason for making the surface 202 curved is in order to ensure a predetermined gap between the micro-lens array 202 and the image sensor 203, even when the micro lens array 202 is rotated around the X axis or around the Y axis by driving the piezo elements 205-1 through 205-4 (refer to FIG. 2).

It should be understood that, in order to facilitate understanding, the curved surface shown in FIG. 4 is exaggerated.

Partition walls 204 for light shielding are provided at the boundary portions between the micro-lenses 202a. These partition walls 204 may, for example, be made as elastic members, and one edge of each of the partition walls 204 is connected to the surface 202d of the micro-lens array 202. Moreover, the other edges of the partition walls 204 are connected to the image sensor 203. The reason for provision of the partition walls 204 is in order to ensure that light that has passed through each of the micro-lenses 202a is only received by the pixel group PXs that is disposed behind that micro-lens 202a (below it in FIG. 4), while ensuring that this light does not fall upon any pixel group PXs that is disposed behind a neighboring micro-lens 202a (below it in FIG. 4).

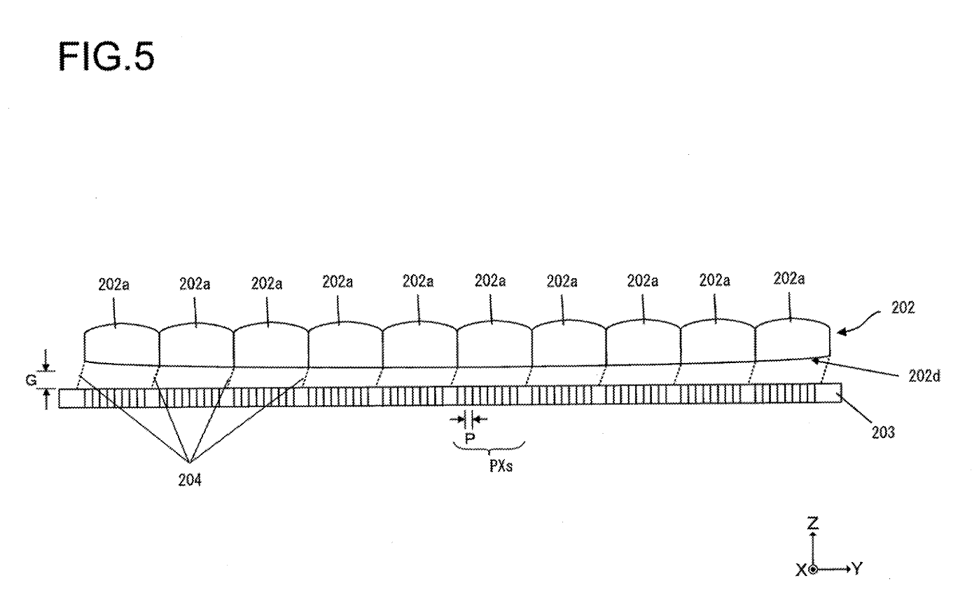

FIG. 5 is a figure for explanation of an example in which the micro-lens array 202 of FIG. 4 is shifted by translation in the +Y axis direction. The direction of shifting and the amount of shifting of the micro-lens array 202 are determined by the control unit 208 on the basis of the result of VR calculation. Due to this, even after shaking of the LF camera 100, the same light as when there was no shaking of the LF camera 100 can be received by each of the pixels of the image sensor 203.

When the positional relationship between the micro-lens array 202 and the image sensor 203 has changed, the partition walls 204 deforms and the light that has passed through each of the micro-lenses 202a is only received by the pixel group PXs that is disposed behind that micro-lens 202a (below it in FIG. 5), while this light is prevented from falling upon any pixel group PXs that is disposed behind a neighboring micro-lens 202a (below it in FIG. 5). Furthermore, a partition wall 204 per se has not been deformed as a whole, due to the portion where that partition wall 204 is connected to the surface 202d of the micro-lens array 202 and the portion where that partition wall 204 is connected to the image sensor 203 being deformed, the light that has passed through the corresponding micro-lens 202a is prevented from falling upon any pixel group PXs that is disposed behind a neighboring micro-lens 202a (below it in FIG. 5).

### VR Operation

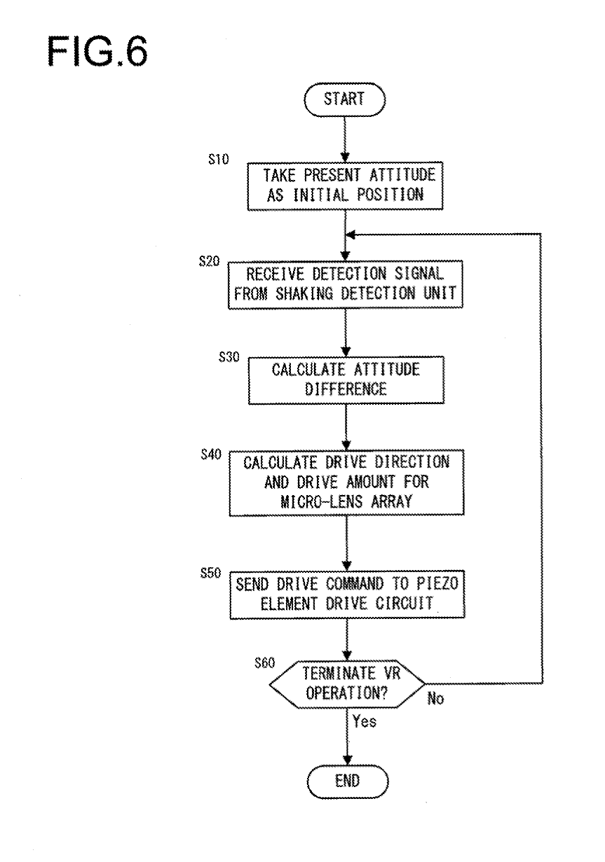

A processing flow executed by the control unit 208 during VR operation will now be explained with reference to the flow chart shown in FIG. 6. The control unit 208 starts the processing shown in FIG. 6 when a VR switch not shown in the figures that is provided to the LF camera 100 is set to ON. A program for performing the processing shown in FIG. 6 may be stored, for example, in a non-volatile memory within the control unit 208.

In step S10 of FIG. 6, the control unit 208 takes the present attitude of the LF camera 100 as being its initial position, and then the flow of control proceeds to step S20. In step S20, the control unit 208 receives the detection signal from the shaking detection unit 207, and then the flow of control proceeds to step S30.

In step S30, on the basis of the detection signal from the shaking detection unit 207, the control unit 208 calculates the attitude difference between the present attitude and the attitude that was calculated during the previous iteration of this routine, and then the flow of control proceeds to a step S40 (but if this is the first iteration after the processing of FIG. 6 has been started, then the initial position is used, instead of the attitude that was calculated during the previous iteration).

In step S40, on the basis of this attitude difference, the control unit 208 calculates a drive direction and a drive amount for the micro-lens array 202 in order to suppress the influence of shaking (i.e. blurring of the image upon the image sensor 203) originating in shaking of the LF camera 100, and then the flow of control proceeds to step S50.

In step S50, the control unit 208 sends a command to the piezo element drive circuit 206, so as to drive each of the four piezo elements 205-1 through 205-4 in the drive direction calculated in step S40 and by the drive amount that has been calculated.

For example, if the micro-lens array 202 is to be shifted by translation in the +Y axis direction with respect to the image sensor 203 (refer to FIG. 1), then each of the piezo elements PZ2 (refer to FIG. 3) incorporated in the piezo elements 205 (i.e. in the piezo elements 205-1 through 205-4 in FIG. 2) is displaced in the +Y axis direction. Due to this, the micro-lens array 202 is shifted in the +Y axis direction with respect to the image sensor 203.

And then in step S60 the control unit 208 makes a decision as to whether or not to terminate VR operation. If the VR switch not shown in the figures has been set to OFF, then in this step S60 the control unit 208 reaches an affirmative decision, and the processing shown in FIG. 6 is terminated. On the other hand, if the VR switch not shown in the figures has not been set to OFF, then in this step S60 the control unit 208 reaches a negative decision, and the flow of control returns to step S20. When the flow of control has returned to step S20, the control unit 208 repeats the processing described above.

### Optical System of LF Camera

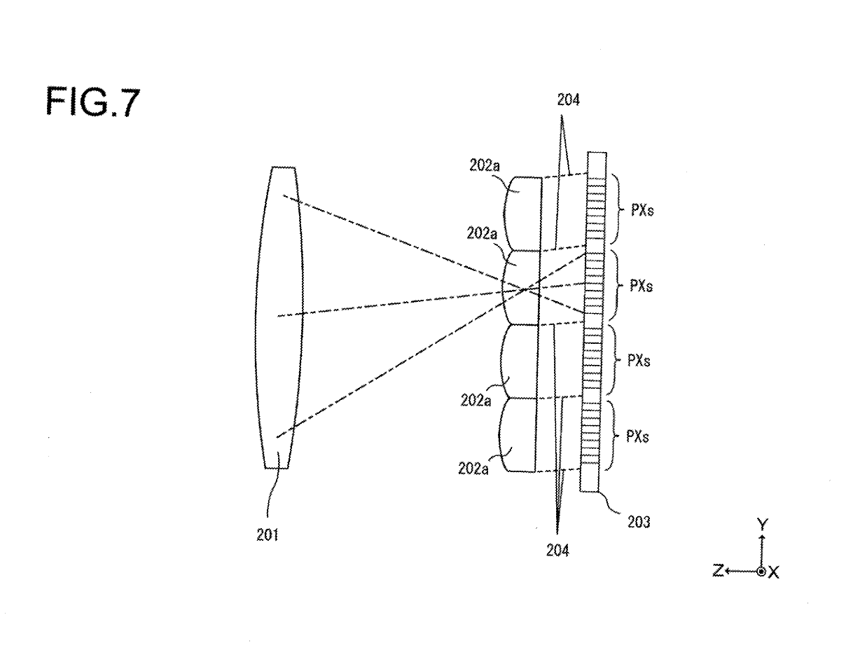

FIG. 7 is a figure schematically showing the optical system of the LF camera 100. The image capturing lens 201 guides the light from the photographic subject to the micro-lens array 202. The light incident upon each of the micro-lenses 202a is from a different portion on the photographic subject. The light incident upon the micro-lens array 202 is divided into a plurality of portions by each of the micro-lenses 202a that constitute the micro-lens array 202. And the light that has passed through each one of the micro-lenses 202a is incident upon the corresponding pixel group PXs of the image sensor 203 that is disposed in a predetermined position behind that micro-lens 202a (to the right thereof in FIG. 7).

In this LF camera 100, the light that has passed through each of the micro-lenses 202a is divided into a plurality of portions by the pixel group PXs that is disposed behind that micro-lens 202a. In other words, each pixel that makes up the pixel group PXs receives light from a single site or portion on the photographic subject that has passed through a different region of the image capturing lens 201.

According to the above structure, for each different site upon the photographic subject, the same number of small images are obtained as the number of micro-lenses 202a, these small images being light amount distributions that correspond to the regions of the image capturing lens 201 through which the light from the photographic subject has passed. In this embodiment, a set of small images of this type is termed an “LF image”.

The thickness of the micro-lens array 202 of the embodiment described above may, for example, be 150 μm. The external diameter of the micro-lens 202a may, for example, be 50 μm. The number of pixels in one pixel group PXs that is disposed behind a single micro-lens 202a (to the right thereof in FIG. 7) may, for example, be several hundred. The pixel pitch P in the pixel groups PXs may, for example, be 2 μm. The maximum displacement in one direction due to the piezo elements 205-1 through 205-4 may, for example, be 6 μm. And the gap between the micro-lens array 202 and the image sensor 203 may, for example, be 10 μm.

With the LF camera 100 described above, the direction in which light is incident upon each pixel is determined by the positions of the plurality of pixels that are disposed behind each micro-lens 202a (to the right thereof in FIG. 7). In other words, since the positional relationship between each micro-lens 202a and the pixels of the image sensor 203 behind it is already known from the camera design information, accordingly the direction of incidence (direction information) of the light rays incident upon each pixel via the corresponding micro-lens 202a can be determined. Due to this, the pixel signal from each pixel of the image sensor 203 represents the intensity of the light from a predetermined incidence direction (i.e. is light ray information).

In this embodiment, light from a predetermined direction that is incident upon a pixel will be termed a “light ray”.

### Effective Range for Reconstruction Processing

Generally, the LF image is subjected to image reconstruction processing by using its data. Such image reconstruction processing is processing for generating an image at any desired focus position and from any point of view by performing calculation (ray rearrangement calculation) on the basis of the above described ray information and the above described direction information in the LF image. Since this type of reconstruction processing is per se known, detailed explanation of the reconstruction processing will here be omitted.

It should be understood that the reconstruction processing may be performed within the LF camera 100 by the image processing unit 210; or, alternatively, it will also be acceptable for data describing the LF image to be recorded on the recording medium 209 and to be transmitted to an external device such as a personal computer or the like, and for the reconstruction processing to be performed by that external device.

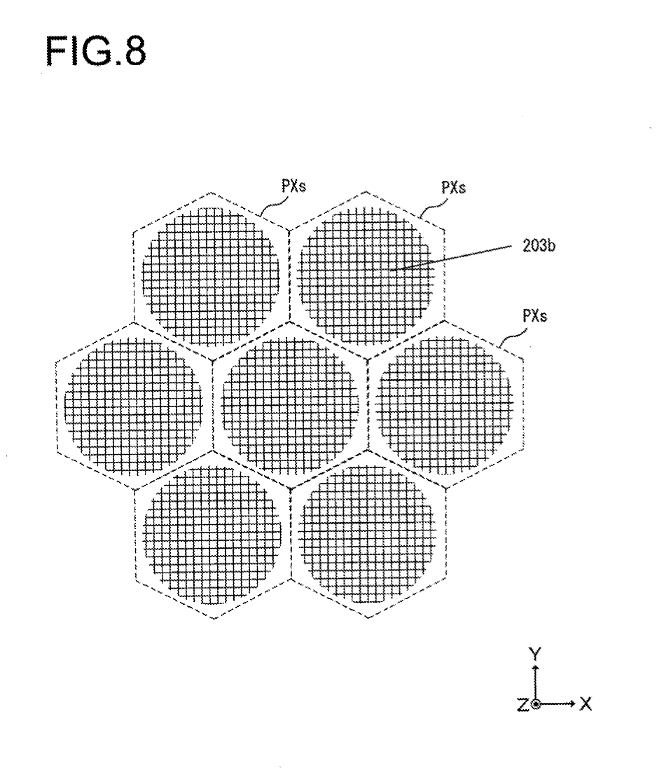

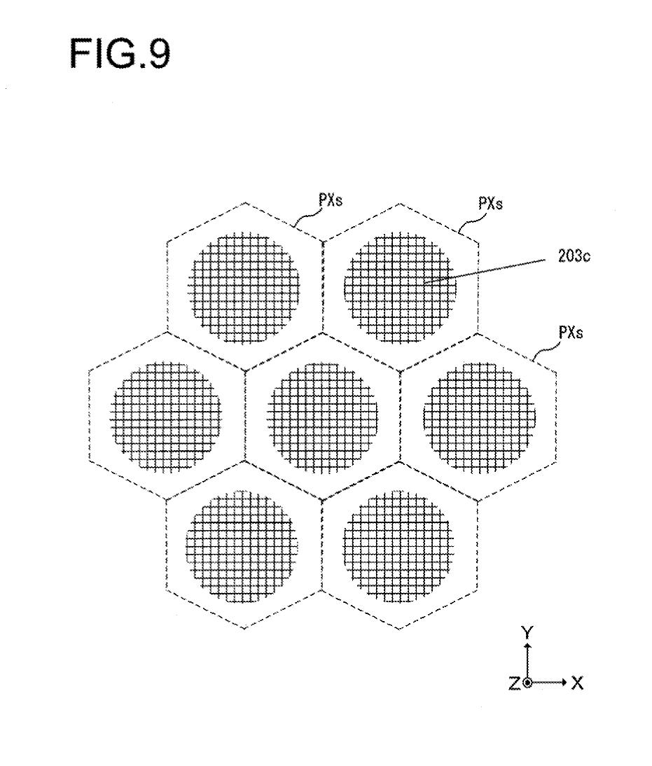

In the reconstruction processing, if metadata indicating that VR operation was taking place is appended to the data for the LF image acquired by the LF camera 100, then the light rays used for the reconstruction processing are restricted. In other words, if such metadata is appended, then part of the light ray information received by the pixel groups PXs disposed behind the micro-lenses 202a is not used in the reconstruction processing. FIG. 8 is a figure showing an example of the pixel groups PXs disposed behind the micro-lens array 202. Normally, the image processing unit 210 performs reconstruction processing by using each of the pixel signals (i.e. the ray information) of the pixel groups PXs corresponding to each of the micro-lenses 202a. The pixel groups PXs have the pixels present in the ranges 203b (the hatched portions). By contrast, if metadata is appended to the data for the LF image, then, as shown in FIG. 9, the image processing unit 210 performs reconstruction processing by using each of the pixel signals (i.e. the ray information) from the ranges 203c (the hatched portions), whose diameters are reduced from the ranges 203b of FIG. 8. It should be understood that the diameters of the ranges 203c may, for example, be reduced from those of the ranges 203b by about 10%.

The reason for limiting the ranges in the pixel groups PXs that are used for reconstruction processing is as follows. When the positional relationship between the micro-lens array 202 and the image sensor 203 has changed, among the pixels in ranges outside of the ranges 203c (the hatched portions), there are some pixels to which light rays do not arrive. In other words, the reliability of the pixel signals (i.e. of the ray information) from pixels in ranges outside of the ranges 203c (the hatched portions) is low. Accordingly, by eliminating from the reconstruction processing the pixel signals (i.e. the ray information) from the pixels that are far from the centers of the pixel groups PXs (i.e. the pixels in ranges that are outside the ranges 203c (outside the hatched portions)), it is possible to avoid inappropriate reconstruction processing when the positional relationship between the micro-lens array 202 and the image sensor 203 has changed.

### Method for Manufacturing Image-Capturing Unit

The procedure for assembly of the image-capturing unit that is mounted to the LF camera 100 will now be explained with reference to FIG. 10. In a first process shown in FIG. 10(a), for example, an operator (this may be a robot) prepares the image sensor 203. The operator mounts the prepared image sensor 203 upon a base portion 150, which is a base member, with the image capturing surface of the image sensor 203 facing upward in FIG. 10(a).

It should be understood that a partition wall 204 is provided at a predetermined position for each of the pixel groups PXs in the image sensor 203, although these partition walls 204 (refer to FIG. 4) are omitted from the figure.

In the second process shown in FIG. 10(b), for example, an operator prepares the micro-lens array 202 and the piezo elements 205 (205-1 through 205-4). And then the operator adheres one end of each of the piezo elements 205 (205-1 through 205-4) to the surface (in FIG. 10(b), the lower surface) of the micro-lens array 202, which is its side toward the image sensor 203, at a respective one of the four corners of the micro-lens array 202 (refer to FIG. 2).

In the third process shown in FIG. 10(c), for example, from above the image sensor 203 that is mounted upon the base portion 150, an operator adjusts the positions of the micro-lenses 202a to the pixel groups PXs of the image sensor 203, and thereby mounts the micro-lens array 202 to which the piezo elements 205 (205-1 through 205-4) are adhered. And the operator adheres the other ends of the piezo elements 205 (205-1 through 205-4) to the base portion 150. By doing this, the image-capturing unit is completed.

It should be understood that it would also be acceptable to vary the order of assembly of the image-capturing unit described above as appropriate. For example it would also be possible, after having mounted the image sensor 203, the piezo elements 205 (205-1 through 205-4), and the partition walls 204 upon the base portion 150, finally to mount the micro-lens array 202 thereupon from above.

According to the embodiment described above, the following advantageous operational effects are obtained.

(1) The image-capturing unit of the LF camera 100 comprises the micro-lens array 202 in which the plurality of micro-lenses 202a are arranged in a two dimensional configuration, the image sensor 203 that photoelectrically converts the light that has passed through the micro-lens array 202, and the piezo elements 205-1 through 205-4 that change the positional relationship between the image sensor 203 and the micro-lens array 202 on the basis of signals representing the shaking of the LF camera 100. Due to this, for example, it is possible to implement VR operation with a smaller structure, as compared to the case when the positional relationship between the image capturing lens 201 and the image sensor 203 is changed.

(2) The piezo elements 205-1 through 205-4 are provided upon the surface 202d of the micro-lens array 202 that faces toward the image sensor 203, and change the position of the micro-lens array 202 with respect to the image sensor 203. Since it is only necessary to shift the micro-lens array 202, accordingly it can be moved with the piezo element 205-1 through 205-4 that are relatively small as compared with voice coil motors.

(3) Since the piezo elements 205-1 through 205-4 are provided at the four corners of the micro-lens array 202 and upon the surface 202d of the micro-lens array 202 that faces toward the image sensor 203, accordingly it is possible to keep the size of the assembly in the X axis direction and in the Y axis direction in FIG. 2 small, as compared to the case in which the piezo elements are provided on side portions of the micro-lens array 202.

(4) With respect to the micro-lens array 202, the piezo elements 205-1 through 205-4 at least provide movement by translation in the directions of two axes (the X axis and the Y axis) that intersect in the two dimensions in which a plurality of the micro-lenses 202a are arranged, and provide rotational movement around the Z axis that is orthogonal to those two axes. Due to this, it is possible to implement appropriate VR operation for suppressing influence due to camera-shaking.

And if, for example, the piezo element PZ1 that performs shifting by translation in the Z axis direction (refer to FIG. 3) is omitted, then it is possible to reduce the thickness in the Z axis direction in FIG. 1, in other words the thickness of the image-capturing unit.

(5) Since the micro-lens array 202 is shifted by the piezo elements 205-1 through 205-4 which are piezoelectric elements, accordingly no stop mechanism, which is required, for example, when a voice coil motor is used, is needed, and therefore it is possible for the structure to be made simple.

(6) When using piezo elements 205-1 through 205-4 that have a displacement amplification function, it is possible to increase the amount of shifting of the micro-lens array 202. The amount of shifting that is suitable for VR operation may, for example, be around 2P to 3P (from twice to three times the pixel pitch).

(7) The image sensor 203 of the LF camera 100 has a large number of pixels that photoelectrically convert the received light, and the micro-lens array 202 of the LF camera 100 is disposed so that a plurality of its pixels receive the light that has passed through a single one of the micro-lenses 202a. And, due to the VR operation in which the micro-lens array 202 is shifted, it is possible appropriately to suppress the influence of camera-shaking during the capture of an LF image.

(8) The partition walls 204 are provided between the micro-lens array 202 and the image sensor 203, and each of them prevents light that has passed through the other micro-lenses 202a from falling upon the plurality of pixels (i.e. the pixel group PXs) that receives light that has passed through one of the micro-lenses 202a. These partition walls 204 prevent light that has passed through the other micro-lenses 202a from falling upon the subject pixel group PXs, even if the positional relationship between the image sensor 203 and the micro-lens array 202 has changed, and accordingly deterioration of the LF image can be prevented.

(9) Since the one edges of the partition walls 204 on their sides toward the micro-lens array 202 are connected to the micro-lens array 202 while their other edges on their sides toward the image sensor 203 are connected to the image sensor 203, accordingly, even when the positional relationship of the image sensor 203 and the micro-lens array 202 has changed, still it is possible reliably to prevent light that has passed through the other micro-lenses 202a from falling upon the subject pixel group PXs.

(10) Since the partition walls 202 are formed as elastic members, accordingly they are deformed according to the positional relationship between the imaging sensor 203 and the micro-lens array 202 when it has changed, so that it is possible reliably to prevent light that has passed through the other micro-lenses 202a from falling upon the subject pixel group PXs.

(11) The LF camera 100 includes the control unit 208 that that generates metadata that is indicative of whether or not to limit the number of signals used in signal processing in which the image is reconstructed by performing predetermined signal processing upon the signals from the plurality of pixels. Due to this, by checking the metadata by an external device which performs reconstruction processing upon the LF image, it becomes possible to avoid inappropriate reconstruction processing.

(12) The control unit 208 generates the metadata described above when the image sensor 203 performs photoelectric conversion in a state in which the positional relationship between the image sensor 203 and the micro-lens array 202 is changed. Due to this it becomes possible, for example, for an external device to make reconstruction processing upon an LF image that has been acquired during VR operation and reconstruction processing upon an LF image that has been acquired during non-VR operation be different, so that it is possible for such an external device to operate satisfactorily in the case where the positional relationship between the micro-lens array 202 and the image sensor 203 changed.

(13) The control unit 208 generates the metadata for limiting the pixel signals that are used for performing reconstruction processing upon an LF image that has been acquired during VR operation. Due to this, it is possible for an external device to avoid performing inappropriate reconstruction processing by using pixel signals whose reliability is low.

Although the use of the light field camera of FIG. 1 has been explained as an embodiment, all of the structural elements thereof are not necessarily essential structural elements of the present invention. For example, the present invention can be built from a micro-lens array 202, an image sensor 203 that photoelectrically converts light that has passed through the micro-lens array 202, and a drive unit that changes the positional relationship of the image sensor 203 and the micro-lens array 202. Even in this case, it is possible to suppress blurring. Furthermore, for example, the present invention can also be built from only a micro-lens array 202 that is disposed so that a plurality of pixels receive light that has passed through a single micro-lens, an image sensor 203 that photoelectrically converts light that has passed through the micro-lens array 202, and a drive unit that changes the positional relationship between the image sensor 203 and the micro-lens array 202. Even in this case, it is possible to suppress blurring during capture of an LF image. Moreover, for example, the present invention can also be built from only a micro-lens array 202 that is disposed so that a plurality of pixels receive light that has passed through a single micro-lens, an image sensor 203 that photoelectrically converts light that has passed through the micro-lens array 202, partition walls 204 that are provided between the micro-lens array 202 and the image sensor 203 and that allow light that has passed through that single micro-lens to be received by a plurality of pixels while preventing light that has passed through other micro-lenses from falling upon those pixels, and a drive unit that changes the positional relationship between the image sensor 203 and the micro-lens array 202. Even in this case, it is possible to prevent light that has passed through the other micro-lenses from falling upon those pixels.

Furthermore, the following modifications also come within the scope of the present invention; and one or a plurality of these variant embodiments may also be combined with the embodiment described above.

### Variant Embodiment #1

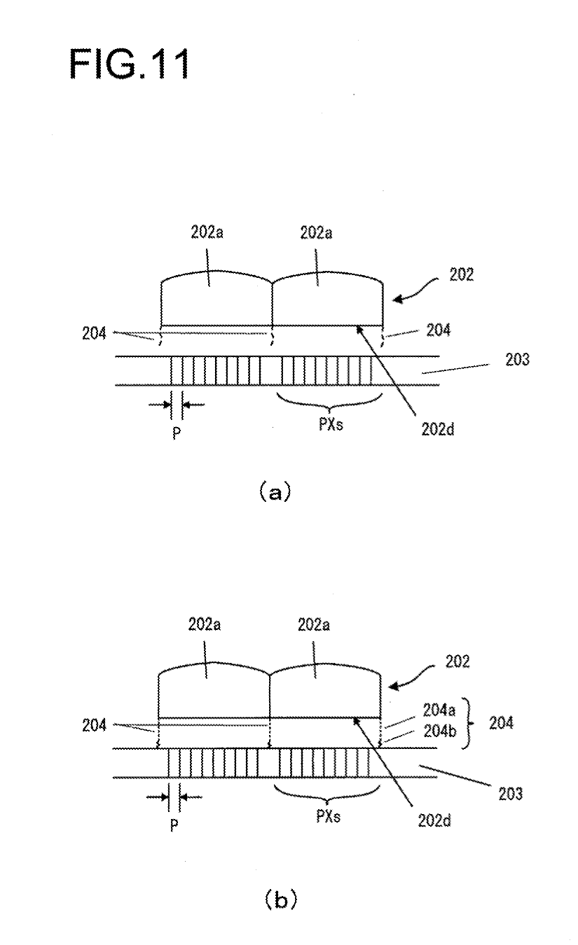

In the embodiment described above (refer to FIGS. 4 and 5), an example was explained in which the one edges of the partition walls 204 were connected to the surface 202d of the micro-lens array 202, while the other edges of the partition walls 204 were connected to the surface of the image sensor 203. Instead of the above, as in the example shown in FIG. 11(a), it would also be acceptable for only the one edges of the partition walls 204 to be connected to the surface 202d of the micro-lens array 202, while the other edges of the partition walls 204 are separated from the image sensor 203. Or, conversely, it would also be acceptable for only the one edges of the partition walls 204 to be connected to the image sensor 203, while the other edges of the partition walls 204 are separated from the micro-lens array 202.

Moreover, as shown by way of example in FIG. 11(b), it would also be acceptable to provide a structure in which the two edges of each of the partition walls 204 are connected to the surface 202d of the micro-lens array 202 and to the surface of the image sensor 203 respectively, and also only portions of the partition walls 204 are built as elastic members. For example, only contact point portions 204b of the partition walls 204 where they are connected to the image sensor 203 (or to the micro-lens array 202) may be built as elastic members, while portions 204a of the partition walls 204 other than those contact point portions are built as non-elastic members.

Furthermore, instead of elastic members that extend and retract by elastic deformation, it would also be acceptable to build portions of the partition walls, or all thereof, by using extensible/retractable members that include extension/retraction mechanisms such as, for example, bellows.

### Variant Embodiment #2

### Positions of Partition Walls

While, in the embodiment described above (refer to FIGS. 4 and 5), an example was explained in which the partition walls 204 were provided between the micro-lens array 202 and the image sensor 203, it would also be acceptable to provide partition walls in front of the micro-lens array 202 (i.e. on its side toward the image capturing lens 201, above in FIG. 4), or to build the partition walls as embedded within the micro-lens array 202.

### Variant Embodiment #3

### Positions of Attachment of Piezo Elements

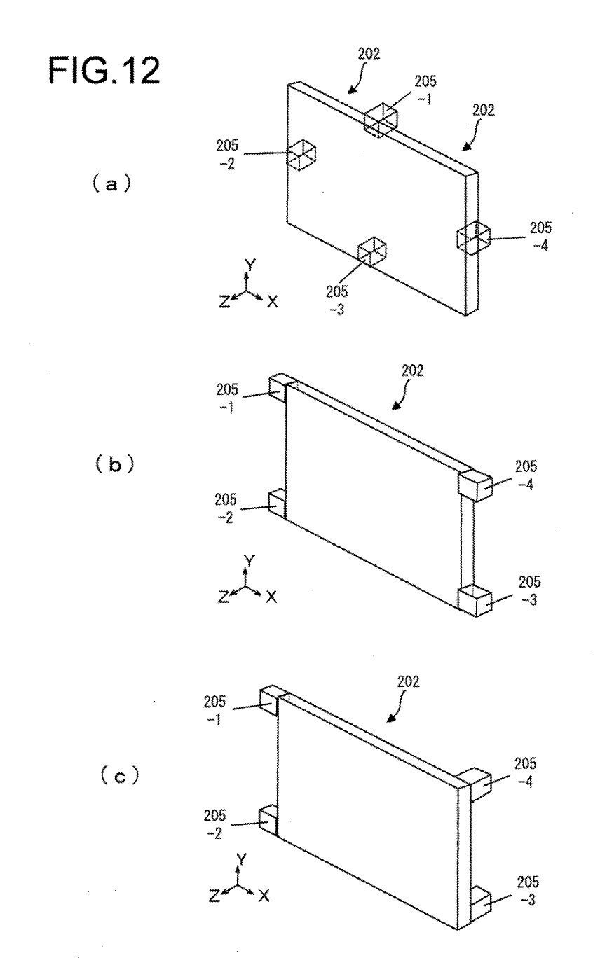

In the embodiment described above (refer to FIG. 2), an example was explained in which the piezo elements 205 (205-1 through 205-4) were respectively provided at the four corners of the rear surface of the micro-lens array 202 (refer to FIG. 2). Instead of this configuration, it would also be acceptable to implement a structure in which, as shown by way of example in FIG. 12(a), the piezo elements 205 (205-1 through 205-4) are provided at the respective sides of the rear surface of the micro-lens array 202. At this time, a structure may be provided in which the piezo elements are located at any desired positions, such as at the central portion of each side, at spots a third the way along from the end of each side, or the like.

Furthermore, as shown by way of example in FIG. 12(b), it would also be acceptable to implement a structure in which the piezo elements 205 (205-1 through 205-4) are provided to respective side portions of the micro-lens array 202 (on the four corners of the side portions, or on the sides of the side portions).

Yet further, as shown by way of example in FIG. 12(c), it would also be acceptable to implement a structure in which some of the piezo elements 205 (for example 205-1 and 205-2) are provided on the side portions of the micro-lens array 202, while the remaining piezo elements 205 (for example 205-3 and 205-4) are provided on the rear surface of the micro-lens array 202.

In this manner, the attachment positions of the piezo elements 205 (205-1 through 205-4) may be varied as appropriate to be at the four corners or the four sides of the micro-lens array 202, or to be on the side portions of the micro-lens array 202 or on its rear surface.

Since, according to this Variant Embodiment #3, on the four sides of the micro-lens array 202, the piezo elements 205 (205-1 through 205-4) are provided at the four sides on the side of the micro-lens array 202 facing toward the image sensor 203 or on the side portions of the micro-lens array 202, accordingly it is possible to dispose the piezo elements 205 (205-1 through 205-4) in positions that are appropriate according to the space available for accommodating the image capturing unit as shown in FIG. 10(c).

### Variant Embodiment #4

### Thin Type Multi-Lens Camera

In the explanation given above, an LF camera was explained in which light from the photographic subject was conducted to the image-capturing unit via an image capturing lens 201, as shown by way of example in FIG. 1. However an LF camera is not limited to this configuration; it would also be possible to build an LF camera to comprise a micro-lens array 202, an image sensor 203, and piezo elements 205, with the image capturing lens 201 being omitted. If the image capturing lens 201 is omitted, then it is possible to obtain a thin type LF camera that is like a card.

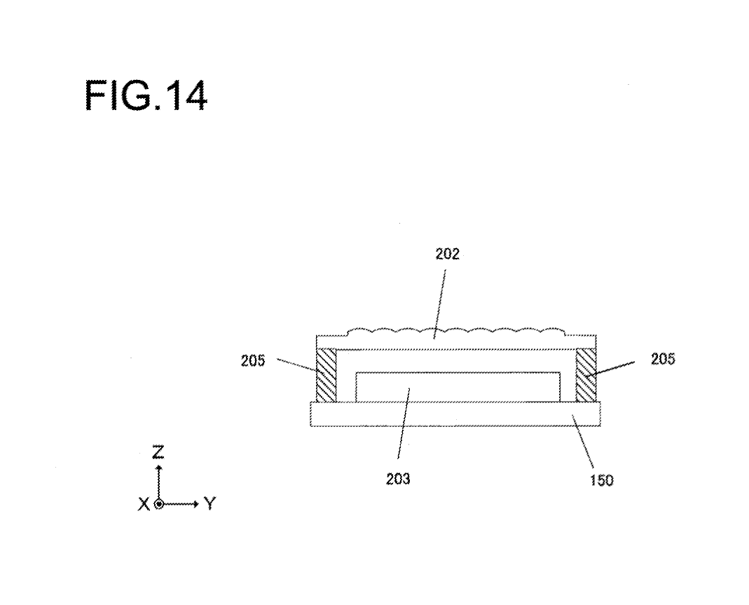

FIG. 13 is a figure showing an example of the external appearance of a thin type LF camera 300. This LF camera 300 comprises, for example, a central portion 301 and a surrounding portion 302. An image-capturing unit that includes a micro-lens array 202, an image sensor 203, and piezo elements 205 (refer to FIG. 14) is disposed in the central portion 301. On the other hand, as shown for example by the broken lines, a battery 302a, a control circuit 302b, a shaking detection unit 302c, a communication unit 302d and so on are disposed in the surrounding portion 302. For example, a rechargeable secondary cell or a capacitor with sufficient charge storage capacity or the like may be used as the battery 302a.

A thin device having the same function as the shaking detection unit 207 already described with reference to FIG. 1 is used as the shaking detection unit 302c. And a thin device having the same functions as the piezo element drive circuit 206 and the control unit 208 already described with reference to FIG. 1 is used as the control circuit 302b. The communication unit 302d has a function of transmitting the image signal captured by the image sensor by wireless communication to an external receiver (for example, an external recording medium that performs image recording, an electronic device such as a smart phone or the like that is endowed with an image display function and/or an image signal memory function, or the like).

It should be understood that it would also be acceptable to provide a structure in which the control circuit 302b is endowed with the function of the image processing unit 210 described above with reference to FIG. 1, and for the control circuit to transmit the image signal to the external receiver after having performed image processing thereupon. It should be understood that the provision of the battery 302a disposed in the surrounding portion 302 is not essential. For example it would be possible to provide a structure in which, by employing per se known electromagnetic induction technology, the LF camera 300 is able to operate even without having a power source.

FIG. 14 shows an example of a sectional view when the central portion 301 of the LF camera 300 of FIG. 13 is cut along the Y axis. In FIG. 14, the image sensor 203 is fixed to a base portion 150, which is a base member. Moreover, the one ends of the piezo elements 205 are fixed to the base portion 150, while the other ends of the piezo elements 205 are fixed to the micro-lens array 202 and support the micro-lens array 202.

In this LF camera 300, the operation of the image-capturing unit including the micro-lens array 202, the image sensor 203, and the piezo element 205 as described with reference to FIG. 14 is the same as in the operation of the LF camera 100 described above.

According to the above described Variant Embodiment #4 relating to a thin type multi-lens camera, the following advantageous operational effects are obtained.

(1) Even if the LF camera 300 is attached to an article of attire (for example to a helmet or the like), it causes no impediment, since it is of the thin type.

(2) Since the LF camera 300 is of the thin type, accordingly it can be bent, and so it can be adhered to an object for mounting that has a curved surface (for example, a utility pole or the like).

(3) Since the LF camera 300 is of the thin type, accordingly it can be stored in a wallet and so on, just like cards of various types.

(4) Since the LF camera 300 is of the thin type, accordingly it does not experience any substantial air resistance when it is fixed to an object (for example to the body of a car or a helicopter or the like).

(5) If the LF camera 300 itself or just the central portion 301 of the LF camera 300 (i.e. its image-capturing unit) is to be incorporated into an object, it can be incorporated without changing the design of the object.

(6) If the LF camera 300 itself or just the central portion 301 of the LF camera 300 (i.e. its image-capturing unit) is to be incorporated into an object, it can be incorporated even if the object is thin.

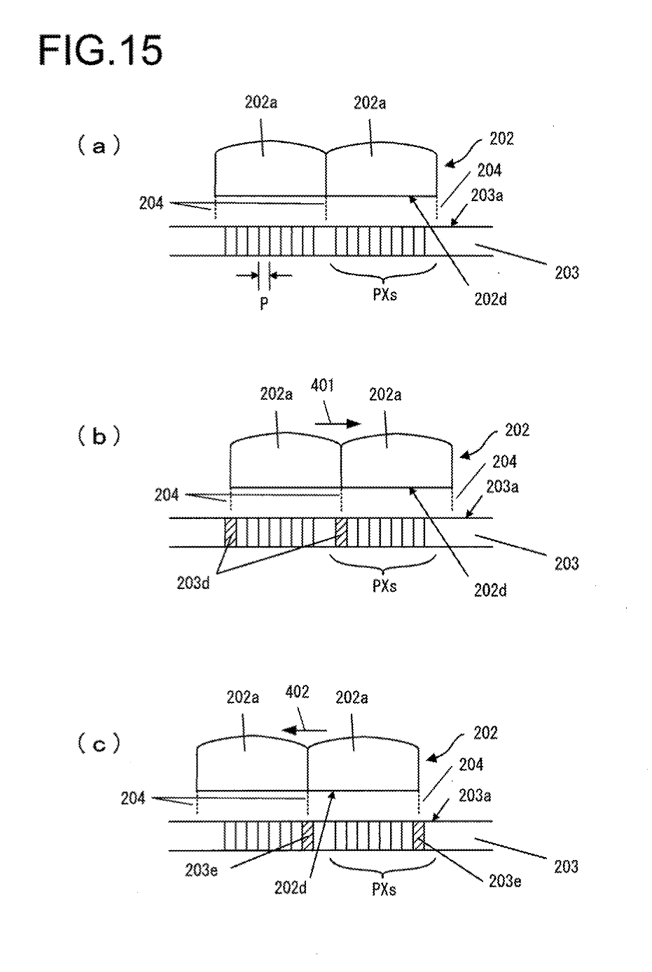

The light that is incident upon the pixel group PXs during VR operation will now be explained with reference to FIGS. 15 through 17.

With reference to FIGS. 15(a) through 15(c), a case will now be explained in which the one edges of the partition walls 204 are connected to the surface 202d of the micro-lens array 202, while the other edges of the partition walls 204 are separated from the surface 203a of the image sensor 203 facing toward the photographic subject. FIG. 15(a) is a figure schematically showing the positional relationship between the micro-lens array 202, the partition walls 204, and the image sensor 203 before the start of VR operation. FIG. 15(b) is a figure schematically showing the positional relationship between the micro-lens array 202, the partition walls 204, and the image sensor 203 when, due to the VR operation, the micro-lens array 202 has shifted rightward in FIG. 15 with respect to the image sensor 203, as shown by the arrow sign 401. FIG. 15(c) is a figure schematically showing the positional relationship between the micro-lens array 202, the partition walls 204, and the image sensor 203 when, due to the VR operation, the micro-lens array 202 has shifted leftward in FIG. 15 with respect to the image sensor 203, as shown by the arrow sign 402.

As shown in FIG. 15(a), before the VR operation starts, light that has passed through each of the micro-lenses 202a is incident upon the corresponding pixel group PXs. However, as shown in FIGS. 15(b) and 15(c), when the positional relationship between the micro-lens array 202 and the image sensor 203 changes due to the VR operation, since the partition walls 204 shift along with the micro-lens array 202, accordingly the positional relationship between the other edges of the partition walls 204 and the image sensor 203 changes. Therefore there is a possibility that light that is incident upon the pixels 203d or the pixels 203e that are positioned at the surrounding edges among the plurality of pixels in each of the pixel groups PXs may be hindered due to the partition walls 204.

Accordingly, if the one edges of the partition walls 204 are connected to the surface 202d of the micro-lens array 202 while the other edges of the partition walls 204 are separated from the surface 203a of the image sensor 203 facing toward the photographic subject, then it is desirable for the control unit 208 to be adapted to generate the metadata described above.

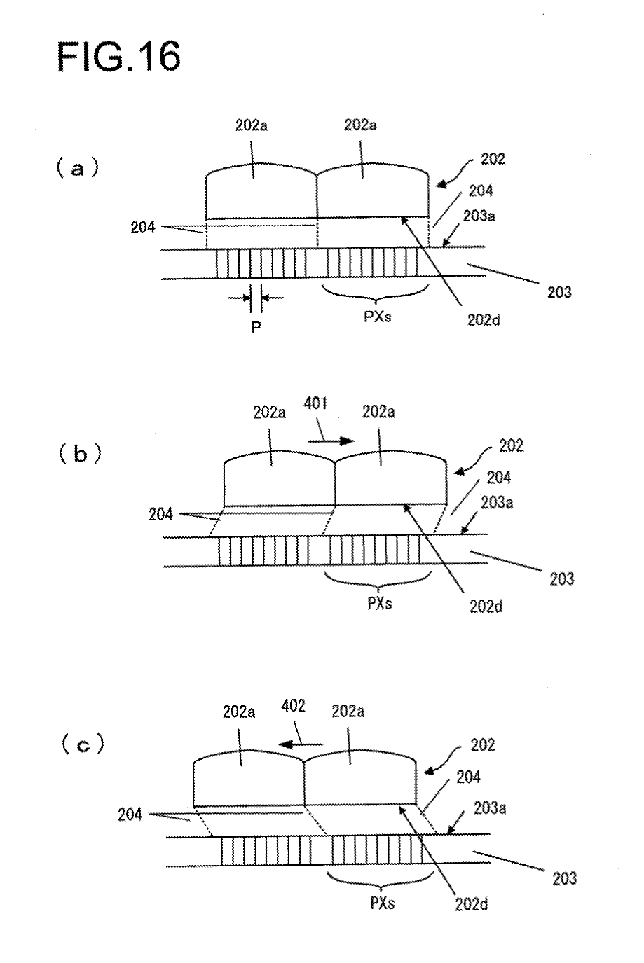

Referring to FIGS. 16(a) through 16(c), the case will now be explained in which the one edges of the partition walls 204 are connected to the surface 202d of the micro-lens array 202, and also the other edges of the partition walls 204 are connected to the surface 203a of the image sensor 203 facing toward the photographic subject. FIG. 16(a) is a figure schematically showing the positional relationship between the micro-lens array 202, the partition walls 204, and the image sensor 203 before the VR operation starts. And FIG. 16(b) is a figure schematically showing the positional relationship between the micro-lens array 202, the partition walls 204, and the image sensor 203 when, due to the VR operation, the micro-lens array 202 has shifted rightward in FIG. 16 with respect to the image sensor 203, as shown by the arrow sign 401. Moreover, FIG. 16(c) is a figure schematically showing the positional relationship between the micro-lens array 202, the partition walls 204, and the image sensor 203 when, due to the VR operation, the micro-lens array 202 has shifted leftward in FIG. 16 with respect to the image sensor 203, as shown by the arrow sign 402.

As shown in FIG. 16(a), before the VR operation starts, light that has passed through each of the micro-lenses 202a is incident upon the corresponding pixel group PXs. However, as shown in FIGS. 16(b) and 16(c), when the positional relationship between the micro-lens array 202 and the image sensor 203 changes due to the VR operation, the one edges of the partition walls 204 shift along with the micro-lens array 202. However, since the other edges of the partition walls 204 are connected to the surface 203a of the image sensor 203 that faces toward the photographic subject, accordingly, even if the positional relationship between the micro-lens array 202 and the image sensor 203 has changed due to the VR operation, still the positional relationship between the other edges of the partition walls 204 and the image sensor 203 does not change. Therefore it is unlikely that light that is incident upon the pixels that are positioned at the surrounding edges among the plurality of pixels in each of the pixel groups PXs may be hindered by the partition walls 204.

Accordingly, if the one edges of the partition walls 204 are connected to the surface 202d of the micro-lens array 202 and also the other edges of the partition walls 204 are connected to the surface 203a of the image sensor 203 facing toward the photographic subject, then it will be acceptable for the control unit 208 not to generate the metadata described above.

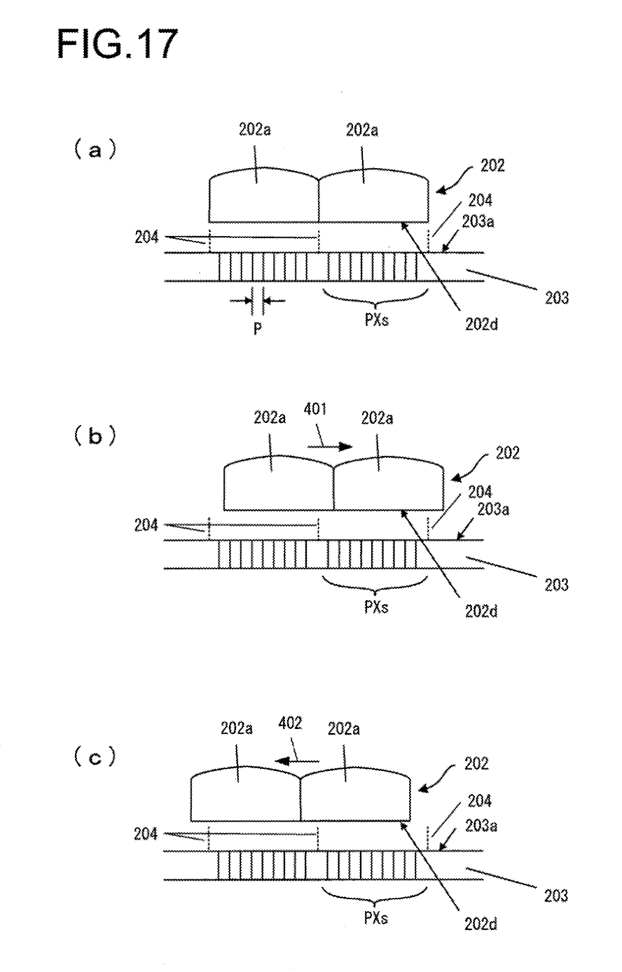

Referring to FIGS. 17(a) through 17(c), the case will now be explained in which the one edges of the partition walls 204 are separated from the surface 202d of the micro-lens array 202, while the other edges of the partition walls 204 are connected to the surface 203a of the image sensor 203 facing toward the photographic subject. FIG. 17(a) is a figure schematically showing the positional relationship between the micro-lens array 202, the partition walls 204, and the image sensor 203 before the VR operation starts. And FIG. 17(b) is a figure schematically showing the positional relationship between the micro-lens array 202, the partition walls 204, and the image sensor 203 when, due to the VR operation, the micro-lens array 202 has shifted rightward in FIG. 17 with respect to the image sensor 203, as shown by the arrow sign 401. Moreover, FIG. 17(c) is a figure schematically showing the positional relationship between the micro-lens array 202, the partition walls 204, and the image sensor 203 when, due to the VR operation, the micro-lens array 202 has shifted leftward in FIG. 17 with respect to the image sensor 203, as shown by the arrow sign 402.

As shown in FIG. 17(a), before the VR operation starts, light that has passed through each of the micro-lenses 202a is incident upon the corresponding pixel group PXs. Moreover, as shown in FIGS. 17(b) and 17(c), even when the positional relationship between the micro-lens array 202 and the image sensor 203 changes due to the VR operation, since the one edges of the partition walls 204 are separated from the surface 202d of the micro-lens array 202 while the other edges of the partition walls 204 are connected to the surface 203a of the image sensor 203 that faces toward the photographic subject, accordingly the positional relationship between the partition walls 204 and the image sensor 203 does not change. Due to this, light that is incident upon the pixels that are positioned at the surrounding edges among the plurality of pixels in each of the pixel groups PXs would not be hindered by the partition walls 204.

Accordingly, if the one edges of the partition walls 204 are separated from the surface 202d of the micro-lens array 202 while the other edges of the partition walls 204 are connected to the surface 203a of the image sensor 203 facing toward the photographic subject, then it will be acceptable for the control unit 208 not to generate the metadata described above.

While various embodiments and variant embodiments have been explained in the above description, the present invention is not to be considered as being limited by the details thereof. Other aspects that are considered to come within the scope of the technical concept of the present invention are also included within the range of the present invention.

The contents of the disclosure of the following application, upon which priority is claimed, are hereby incorporated herein by reference:

Japanese Patent Application No. 2015-68875 (filed on 30 Mar. 2015).

### REFERENCE SIGNS LIST

100, 300 . . . LF cameras
150 . . . base portion
201 . . . image capturing lens
202 . . . micro-lens array
202a . . . micro-lenses
203 . . . image sensor
204 . . . partition walls
205 (205-1 through 205-4, PZ 1 through PZ 3) . . . piezo elements
206 . . . piezo element drive circuit
207 . . . shaking detection unit
208 . . . control unit
209 . . . recording medium
210 . . . image processing unit
PXs . . . pixel group

1. An image-capturing device, comprising:
a micro-lens array in which a plurality of micro-lenses are arranged in a two dimensional configuration;
an image sensor that comprises a plurality of pixel groups each comprising a plurality of pixels, and that receives light with each of the pixel groups that has passed through a respective micro-lens of the micro-lens array;
a drive unit that changes a positional relationship of the image sensor and the micro-lens array: and
partition walls that are provided between the micro-lens array and the image sensor, and that allow light that has passed through a single micro-lens to be received by a corresponding pixel group of the pixel groups, while hindering light that has passed through others of the micro-lenses from falling upon the corresponding pixel group.

2. The image-capturing device according to claim 1, wherein:
the drive unit changes the positional relationship of the image sensor and the micro-lens array based on a signal that indicates shaking of the image-capturing device.

3. The image-capturing device according to claim 1, wherein:
the drive unit is provided upon at least one of a portion of the micro-lens array facing toward the image sensor and a side portion of the micro-lens array, and changes a position of the micro-lens array with respect to the image sensor.

4. The image-capturing device according to claim 3, wherein:
the drive unit is provided at four corners of the micro-lens array, upon the portion of the micro-lens array facing toward the image sensor or the side portion of the micro-lens array.

5. The image-capturing device according to claim 3, wherein:
the drive unit is provided at four sides of the micro-lens array, upon the portion of the micro-lens array facing toward the image sensor or the side portion of the micro-lens array.

6. The image-capturing device according to claim 1, wherein:
the drive unit at least shifts the micro-lens array by translation along directions of two axes that intersect on the two dimensional configuration in which the plurality of micro-lenses are arranged, and rotationally around an axis that is orthogonal to the two axes.

7. The image-capturing device according to claim 1, wherein:
the drive unit includes a piezoelectric element.

8. The image-capturing device according to claim 7, wherein:
the piezoelectric element has a displacement amplification function.

9-10. (canceled)

11. The image-capturing device according to claim 1, wherein:
the partition walls are disposed so that either the partition walls and the micro-lens array, or the partition walls and the image sensor, are separated from one another.

12. The image-capturing device according to claim 1, wherein:
portions of the partition walls that face toward the micro-lens array are connected to the micro-lens array, and portions of the partition walls that face toward the image sensor are connected to the image sensor.

13. The image-capturing device according to claim 12, wherein:
at least portions of the partition walls are formed as elastic members.

14. The image-capturing device according to claim 1, further comprising:
an information generation unit that generates information specifying limitation on signals from the pixel groups upon the positional relationship between the image sensor and the micro-lens array being changed.

15. The image-capturing device according to claim 14, wherein:
upon performing by the image sensor photoelectric conversion in a state in which the positional relationship between the image sensor and the micro-lens array has changed, the information generation unit generates appended information specifying that a number of signals used for signal processing is limited.

16. The image-capturing device according to claim 15, wherein:
the information generation unit generates appended information specifying that the number of the signals is limited by eliminating a signal from a pixel at an edge portion of a pixel group that receives light that has passed through a single micro-lens.

17. A multi-lens camera comprising an image-capturing device according to claim 1.

18. A method for manufacturing an image-capturing device, comprising:
preparing a micro-lens array in which a plurality of micro-lenses are arranged in a two dimensional configuration;
preparing an image sensor that comprises a plurality of pixel groups each comprising a plurality of pixels, and that receives light with each of the pixel groups that has passed through a respective micro-lens of the micro-lens array;
preparing a drive unit that changes a positional relationship of the image sensor and the micro-lens array;
preparing partition walls that are provided between the micro-lens array and the image sensor, and that allow light that has passed through a single micro-lens to be received by a corresponding pixel group of the pixel groups, while hindering light that has passed through others of the micro-lenses from falling upon the corresponding pixel group; and
assembling together the micro-lens array, the image sensor, the drive unit, and the partition walls.

19. An image-capturing device, comprising:
a micro-lens array in which a plurality of micro-lenses are arranged in a two dimensional configuration;
an image sensor that comprises a plurality of pixel groups each comprising a plurality of pixels, and that receives light with each of the pixel groups that has passed through a respective micro-lens of the micro-lens array; and
partition walls that are provided between the micro-lens array and the image sensor, and that allow light that has passed through a single micro-lens to be received by a corresponding pixel group of the pixel groups, while hindering light that has passed through others of the micro-lenses from falling upon the corresponding pixel group;
wherein the partition walls are arranged so as, even if the positional relationship between the image sensor and the micro-lens array changes, to allow light that has passed through the single micro-lens to be received by the corresponding pixel group, while hindering light that has passed through others of the micro-lenses from falling upon the corresponding pixel group.

20. An image-capturing device, comprising:
a micro-lens array in which a plurality of micro-lenses are arranged in a two dimensional configuration;
an image sensor that comprises a plurality of pixel groups each comprising a plurality of pixels, and that receives light with each of the pixel groups that has passed through a respective micro-lens of the micro-lens array;
partition walls that are provided between the micro-lens array and the image sensor, and that allow light that has passed through a single micro-lens to be received by a corresponding pixel group of the pixel groups, while hindering light that has passed through others of the micro-lenses from falling upon the corresponding pixel group; and
an information generation unit that generates information specifying limitation on signals from the pixel groups upon a positional relationship between the image sensor and the micro-lens array being changed.
